(19) United States
(12) Patent Application Publication
(10) Pub. No.: US 2024/0119389 A1
(43) Pub. Date: Apr. 11, 2024

(54) APPLICATION RATIONALIZATION AUTOMATION METHODOLOGY

(71) Applicant: Insight Direct USA, Inc., Chandler, AZ (US)

(72) Inventors: Mark Candelora, Reading, MA (US); Scott Lowery, Scottsdale, AZ (US); Sara Smiles, McMurray, PA (US); Scott Morgan, Wilmington, NC (US); Katie Ryan, Boston, MA (US); Ish Haque, Charlotte, NC (US)

(21) Appl. No.: 18/376,278

(22) Filed: Oct. 3, 2023

Related U.S. Application Data
(60) Provisional application No. 63/414,121, filed on Oct. 7, 2022.

(51) Int. Cl. G06Q 10/0637

(52) U.S. Cl. CPC G06Q 10/0637

(57) ABSTRACT

A method of administering a survey includes collecting response data from an introductory question set selected from the questions of the survey. The method calculates disposition probabilities based on the response data and a probability difference between two of the disposition probabilities. The method ends the survey based on a comparison between the probability difference and a probability difference threshold criterion.

### CROSS-REFERENCE TO RELATED APPLICATION

This application is a nonprovisional application claiming the benefit of U.S. provisional application Ser. No. 63/414,121, filed on Oct. 7, 2022, entitled “APPLICATION RATIONALIZATION AUTOMATION METHODOLOGY” by Mark Candelora, Scott Lowery, Sara Smiles, Scott Morgan, Katie Ryan, and Ish Hague.

### BACKGROUND

This disclosure relates generally to application rationalization. More specifically, this disclosure relates to methods for obtaining application and organizational information that are used to provide a migration and/or modernization recommendation.

Application rationalization is the process of reviewing an organization's application portfolio and providing a recommendation for each application regarding application migration and/or application modernization. The rationalization process includes information collected from stakeholders within the organization using detailed surveys and/or interviews. Organizations with relatively large application portfolios may include hundreds or even thousands of applications. Collection and compilation of application information and/or organizational preferences along with analysis of the application information and organizational preferences may require significant personnel and/or computational resources.

### SUMMARY

A method of administering a survey in accordance with an example embodiment of this disclosure includes administering an introductory question set to a stakeholder via a user interface and collecting response data from the introductory question set. The method includes determining, using a logistic regression model, disposition probabilities based on response data from the introductory question set. Each disposition probability is representative of a likelihood a disposition recommendation is selected from a plurality of disposition recommendations. The method includes determining a probability difference from two of the disposition probabilities and comparing the probability difference to a probability difference threshold. The method includes ending the survey upon determining the probability difference is equal to or greater than the probability difference threshold.

In a further example embodiment of this disclosure, the method includes administering an additional question or questions upon determining the probability difference is less than the probability difference threshold. The additional question or questions are selected in order of decreasing question importance assigned based on weights of the logistic regression model. The method includes determining second disposition probabilities based on response data from the introductory question set and the additional question or questions. The method includes determining a second probability difference and comparing the second probability difference to the probability difference threshold. The method ends the survey if the second probability difference is equal to or greater than the probability difference threshold.

### BRIEF DESCRIPTION OF THE DRAWINGS

FIG. 1 is a block diagram of an example application rationalization system.

FIG. 2 is a block diagram of an example survey module that includes a set of categorized questions.

FIG. 3 is a block diagram illustrating the relationship among a rationalization model, a comparator module, the survey module, a user interface, and a training module of the example application rationalization system.

FIG. 4 is a flow chart describing an example method of administering questions of the example application rationalization system.

### DETAILED DESCRIPTION

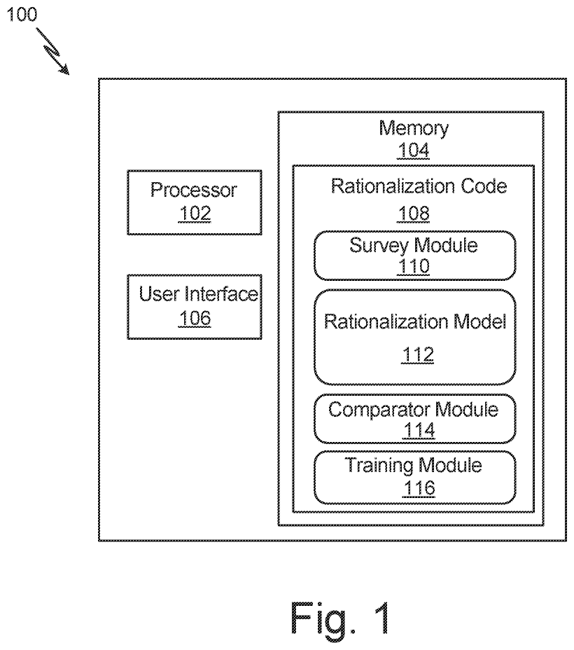

FIG. 1 is a block diagram of application rationalization system 100, which is a computing device configured to implement one or more data models used to perform methods described herein, and also automatic termination of a survey based on response data from less than all of the survey questions. Application rationalization system 100 includes processor 102, memory 104, and user interface 106. Memory 104 stores rationalization code 108, which can be used to administer survey questions to one or more stakeholders of an organization via user interface 106. Rationalization code 108 evaluates question response data during the administration of the survey to determine a prioritized order of questions and, when the likelihood of a particular disposition meets predetermined criteria, provide a recommendation for a given application regarding migration and/or modernization. By following this prioritized approach, application rationalization system 100 can provide a recommendation based on less than all questions of the survey, reducing the time required by stakeholders to provide information and subject matter experts to analyze response data.

Processor 102 can execute rationalization code 108 and other software, applications, programs, and/or models stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium or computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that does not maintain stored contents when power to the memory 104 is turned off. Examples of volatile memories can include random access memories (RAM), dynamic random access memories (DRAM), static random access memories (SRAM), and other forms of volatile memories. In some examples, memory 104 is used to store program instructions for execution by processor 102. Memory 104, in one example, is used by software or applications running on the application rationalization system (e.g., by a computer-implemented data processing module) to temporarily store information during program execution.

Memory 104, in some examples, also includes one or more computer-readable storage media. The memory can be configured to store larger amounts of information than volatile memory. The memory can further be configured for long-term storage of information. In some examples, the memory includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and enables application rationalization system 100 to administer survey questions to a stakeholder of an organization. For example, user interface 106 can be configured to output one or more questions 118 and receive inputs (e.g., response data) from the stakeholder. User interface 106 can include one or more of a sound card, a video graphics card, a speaker, a display device (such as a liquid crystal display (LCD), a light emitting diode (LED) display, an organic light emitting diode (OLED) display, etc.), a vibration or rumble motor, an accelerometer, a touchscreen, a keyboard, a mouse, a joystick, or other type of device for facilitating input and/or output of information in a form understandable to users and/or machines.

Application rationalization system 100 is configured to perform one or more methods described herein. Application rationalization system 100 can be operably connected to a server, a database, or other remote computing device via a wired or wireless communication network (or both). Application rationalization system 100 can accept data from or other information about applications or other software programs stored and/or executed by the server, database, or other remote computing device via the wired and/or wireless communication network. Application rationalization system 100 may use such data or other information to determine a disposition recommendation, as is further described below. More generally, application rationalization system 100 is configured to perform any of the functions attributed herein to an application rationalization system 100, including receiving an output from any source referenced herein and generating and providing data and information as referenced herein.

Application rationalization system 100 can be a discrete assembly or formed by one or more devices capable of individually or collectively implementing functionalities, generating data, and outputting data as discussed herein. In some examples, application rationalization system 100 can be implemented as a plurality of discrete circuitry subassemblies. In some examples, application rationalization system 100 can include or be implemented at least in part as a smartphone or tablet, among other options. In some examples, application rationalization system 100 and/or user interface 106 of application rationalization system 100 can include and/or be implemented as downloadable software in the form of a mobile application. The mobile application can be implemented on a computing device, such as a personal computer, tablet, or smartphone, among other suitable devices. Application rationalization system 100 can be considered to form a single computing device even when distributed across multiple component devices.

Rationalization code 108 includes survey module 110, rationalization model 112, comparator module 114, and training module 116 that automate the process of administering a set of questions, gathering response data pertaining to application information and/or organizational preferences, and analyzing said data to identify additional questions to administer and/or provide a disposition recommendation.

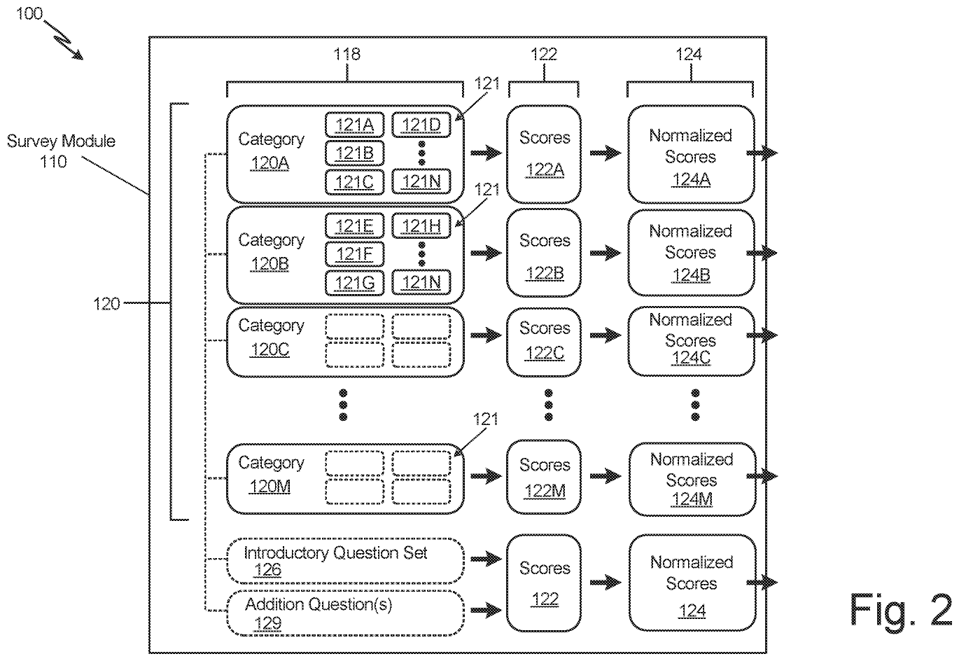

FIG. 2 is a block diagram of survey module 110, which interfaces with stakeholders within an organization to gather information relating to one or more applications and organization preferences. Stakeholders can include leadership personnel within the organization or personnel within business and/or technical management. Other stakeholders can include software engineers or other personnel that create, manage, support, and/or use applications. Survey module 110 includes a set of questions 118, each question designed to elicit information from one of categories 120A, 120B, and up to an arbitrary number of categories 120M (“M” denoting an arbitrary number). One or more of categories 120A-120M may further be divided into one or more subcategories 121A, 121B, and up to an arbitrary number of subcategories 121N (“N” denoting an arbitrary number that is not necessarily equal to the arbitrary number of categories “M,” and which can be greater than, equal to, or less than the arbitrary number of categories “M”). In some examples, survey module 110 can include organization-specific questions, application-specific questions, or a mix of organization-specific questions and application-specific questions, which are used by system 100 to define characteristics of each application and the modernization preferences and/or migration preferences of the organization.

Questions 118 are closed-form questions in which each question 118 is associated with a fixed set of responses rather than an unlimited (i.e., open) response field. Some or all of questions 118 can be associated with the same set of responses. In other examples, at least one or more of questions 118 has a fixed set of responses that is different from response sets of other questions 118. Responses within each set of questions is assigned a score 122. In some examples, the total number of questions 118 combined from each category 120 and subcategory 121 can be greater than twenty-five questions 118. In other examples, the total number of questions 118 can be greater than fifty questions 118. In yet other examples, the total number of questions 118 can be greater than one hundred questions 118. While the number of questions 118 in the survey may vary among specific implementations of survey module 110, application rationalization system 100 can arrive at a disposition recommendation based on a subset of the total number of questions 118 available using the methods and devices described herein.

Organization-specific questions may relate to an organization's desire to innovate, cost of innovation, risk tolerance, market risk, market differentiation, market position and/or competitors, among other potential questions. Questions directed to an organization's desire to innovate include whether the organization uses primarily old or new technologies and whether the organization prefers efficiency over innovation and vice versa. An organization's desire to innovate may also depend on whether the organization has a niche or broad market share. The organization's costs associated with innovation include the presence or absence of legal obligations and/or regulations or the adherence to industry standards that are required to operate. An organization's risk probability increases or decreases based on the degree of market differentiation and market maturity as well as the number of competitors within the market. Questions directed to financial risk and security risk, among other questions, can characterize an organization's risk tolerance.

Application-specific questions may relate to an application's architecture, framework, value, operational risk, and/or operational costs as well as an application's potential for innovation, migration options, and costs of migration. Questions directed to the application type, application priority, technologies used by the application, the application's lifecycle, and the availability of alternative or duplicate applications that perform the same workload help define the scope and cost of application migration.

Application value can be elicited by questions directed to the application's technical and sales impact and the degree of market differentiation between the application and other applications within the market. The quantity of application users and revenue generated by leveraging the application are indicative of application value. Whether or not the application is partner-facing, vendor-facing, and/or customer-facing as well as the degree of application alignment with an organization's goals also describe an application's value. Questions pertaining to the time for an application to reach stable operation, the difficulty making changes to the application, the frequency of new releases may characterize an application's time to market, which may increase or decrease the application's value. Similarly, questions characterizing the ability to innovate or improve the application include the number of help desks calls pertaining to the application, the training effort required to use the application, and the cost of hosting the application. Additional factors influencing an applications ability to innovate include whether the hosting arrangement matches current and future requirements and the effort required to support the application. Questions providing information about the existence or absence of issues related to scaling the application or application performance as well as the existence of useability, stability, or global support issues also increase or decrease an application's value.

The type of response data and/or the number of potential responses to questions 118 can vary from question to question. In some instances, questions 118 may elicit a response among a range of integers. In other examples, responses can be a fixed set of textual responses such as true/false, never/sometimes/always, strongly disagree/sometimes disagree/neutral/sometimes agree/strongly agree and the like. In some instances, textual responses are converted to an integer range. For example, a true-false question may receive a “0” for false and a “5” for true. A never-sometimes-always question may receive a “0” for never, a “3” for sometimes, and a “5” for always. A disagree-neutral-agree question may receive a “0 for strongly disagree, a “1” for sometimes disagree, a “2” for neutral, a “3” for sometimes agree, and a “4” for strongly agree. Although, it will be understood that any range of scores can be applied to textual and numeric response data as long as the question and corresponding set of potential responses are consistent. For example, higher scores associated with questions about an application's value can be consistently associated with higher value and lower scores can be consistently associated with lower value or vice versa. The range of scores 122 for each question may be the same or different.

Whether or not the range of scores 122 for each question differ, scores 122 can be normalized to a common range of scores (i.e., a normalized score 124). In some examples, normalized score 124 can be any value between zero and one, though normalized score 124 can be associated with any range common to all questions 118. Normalized score 124 is calculated as the quotient in which the numerator is the response value, X, minus the minimum score of the question, Xₘᵢₙ, and the denominator is the maximum score, Xₘₐₓ, minus the minimum score of the question, Xₘᵢₙ.

As shown in FIG. 2, scores 122 can be divided into subsets of scores associated with each of categories 120 and/or subcategories 121. For example, scores 122A are a subset of scores 122 associated with questions 118 of category 120A. Scores 122B are a subset of scores 122 associated with questions 118 of category 120B, and scores 122C are a subset of scores 122 associated with questions 118 of category 120C. While three categories 120 are discussed in this example embodiment, additional subsets of scores can be associated with each of up to an arbitrary number “M” of categories (e.g., up to scores 122M). Each subset of scores 122A, 122B, 122C, and up to scores 122M is normalized as represented by normalized scores 124A, 124B, 124C, and up to normalized scores 124M.

Survey module 110 may be configured to provide introductory question set 126 at the start of the survey, represented by a dashed box in FIG. 2. Introductory question set 126 contains a subset of questions 118 that can be selected from one or more categories 120 and/or one or more subcategories 121 described above. The number of questions within introductory question set 126 is small relative to the total number of questions 118 available to survey module 110. The number of questions within introductory question set 126 can be determined during training of rationalization model 112, the specific number of questions 118 selected based on model performance and accuracy. Questions 118 of introductory question set 126 can be a fixed set of questions that does not vary from application to application of an organization's portfolio. In some instances, introductory question set 126 includes questions 118 that have been determined via training to have the highest importance (i.e., to be the most impactful to determining a disposition recommendation). In some instances, introductory question set 126 can include organization-specific questions (category 120A) that identify organizational preferences and goals pertaining to its application portfolio. For example, introductory question set 126 can include question 118 directed to an organization's desire to innovate (subcategory 121A), cost of innovation (subcategory 121B), probability of market risk (subcategory 121C), and/or risk tolerance (subcategory 121D). Introductory question set 126 can, in still other instances, include application-specific questions (category 120B) directed to an application's value (subcategory 121E), time-to-market (subcategory 121F), ability-to-innovate (subcategory 121G), and/or application risk (subcategory 121H). In yet other instances, introductory question set 126 includes application migration scoping questions (category 120C). Irrespective of the number, category, and subcategory of questions 118 within introductory question set 126, responses elicited by introductory questions set 126 provides response data (e.g., a subset of normalized scores 124) to rationalization model 112 for analysis.

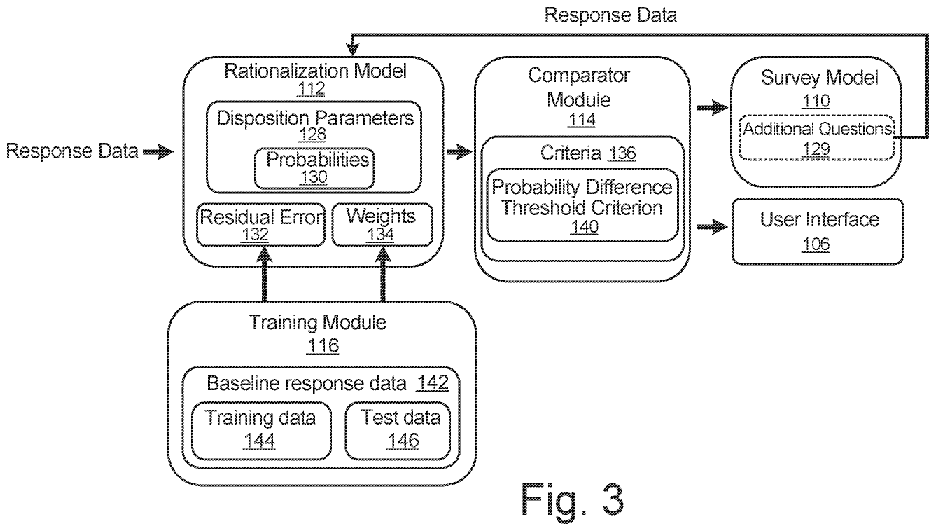

FIG. 3 is a block diagram illustrating the relationship among rationalization model 112, comparator module 114, survey module 110, user interface 106, and training module 116. Rationalization model 112 is a machine learning model configured to output one or more disposition parameters 128 based on response data received from introductory question set 126 and, in some cases, response data from one or more subsequently administered additional questions 129. Additional questions 129 can include any question 118 within any of categories 120 and/or subcategories 121 that are not associated with introductory question set 126.

In one example, rationalization model 112 is based on multiple one-versus-all (sometimes referred to as one-versus-rest) algorithms. Each one-versus-all algorithm compares one of the potential disposition recommendations (e.g., retire, retain, replace, rehost, refactor, rearchitect, and re-envision) to all other potential disposition recommendations. In this example, rationalization model 112 determines at least one disposition parameter 128 associated with each disposition taking the form of probabilities 130. Each probability 130 represents a predicted likelihood that a particular disposition occurs over all other dispositions. Rationalization model 112 can include multiple one-versus-all algorithms, each algorithm determining one of probabilities 130 associated with a different one of the disposition recommendations.

The disposition probabilities can be determined by the rationalization model 112 using a variety of techniques. In one example, each disposition probability 130 can be determined by rationalization model 112 using logistic regression techniques. For example, the disposition probability for each potential disposition “i” (e.g., retire, retain, replace, rehost, refactor, rearchitect, and re-envision), can be determined from Equation (1) below, in which: β₀ represents residual error 132; β1, β2, . . . , βp represent model weights 134 for respective factors x₁, x₂, . . . , xₚ; and factors x₁, x₂, . . . , xₚ represent response data associated with respective questions 118. Unadministered or unanswered questions 118 receive a null value for factor x and hence do not contribute to the disposition probability (P). Residual error 132 and model weights 134 are determine by training rationalization model 112 using techniques described below. After training, the disposition probability (P) is calculated for each potential disposition “i” to define disposition probabilities 130, which are output to comparator module 114.

$$\\ \begin{matrix}P ( {y}^{i} = 1 ) = \frac{1}{1 + exp [ - {β}_{0} + {β}_{1} {x}_{1}^{i} + … + {β}_{p} {x}_{p}^{i} ) ]} & Equation ( 1 )\end{matrix}$$

Comparator module 114 evaluates disposition probabilities 130, or other disposition parameters 128 derived from disposition probabilities 130 against at least one criterion 136. In the present example, comparator module 114 ranks disposition probabilities 130 in ascending or descending order. Disposition parameters 128 include probability difference 138, which is derived from disposition probabilities 130. Probability difference 138 equals the difference between the greatest disposition probability and the second-greatest disposition probability, which is determined by comparator module 114. The probability difference 138 is compared to probability difference threshold criterion 140, which can be determined by training comparator module 114 using techniques described below. In some examples, the probability difference threshold criterion is equal to or greater than 0.25 (or 25%). In other examples, the probability difference threshold criterion is equal to or greater than 0.30 (or 35%). In still other examples, the probability difference threshold criterion is equal to or greater than 0.45 (or 45%). If the probability difference equals or exceeds the probability difference threshold, comparator module 114 outputs the disposition with the highest probability to user interface 106. If the probability difference is less than the probability difference threshold, comparator module 114 signals the survey module 110 to submit at least one additional question 129 via user interface 106. In other examples, survey module 110 administers a set of additional questions 129. As before, additional questions 129 can be selected from any category 120 or subcategory 121 of questions 118. In each instance, survey module 110 selects questions 118 in order of highest to lowest question importance. Response data from one or more additional questions 129 augments the response data received in response to introductory question set 126. The rationalization model 112 updates disposition probabilities 130 based on the augmented response data (i.e., response data from introductory set 126 and additional questions 129) and the comparator module 114 reevaluates the updated disposition probabilities 130 by comparison to probability difference threshold criterion 140 as previously described.

The application rationalization system 100 can execute the machine learning training module 116 to train rationalization model 112 based on baseline response data 142, which contains sets of response data. Each set of response data corresponds to a complete survey pertaining to a single application. The baseline response data 142 is split into a first dataset 144 and a second dataset 146 for training the rationalization model 112. The first dataset 144 can be referred to as training data and the second data set 146 can be referred to as testing data. Each set of response data forming the baseline response data 142 is placed in one of the first dataset 144 and the second dataset 146. The sets of response data are randomly assigned to the two datasets such that the sets of response data in each of the first dataset 144 and the second dataset 146 are representative of typical disposition recommendations. As such, each of the first dataset 144 and the second dataset 146 is representative of the disposition recommendations as a whole. The first dataset 144 includes more sets of response data than the second dataset 146. In one example, the first dataset 144 is formed by two thirds of the baseline response data 142 and the second dataset 146 is formed by one third of the baseline response data 142. The first dataset 144 can be formed by 60%, 70%, 80% or another majority percentage of the baseline response data 142. For example, the first dataset 144 can include a majority number of response data sets of the baseline response data 142. The second dataset 146 is formed by the remainder of the baseline response data 142, such as 40%, 30%, 20%, or another minority percentage of the baseline response data 142. For example, the second dataset 146 can include a minority number of response data sets of the baseline response data 142.

Training of the rationalization model includes an initial training based on the first dataset 144 and testing of that initially trained model based on the second dataset 146. The rationalization model 112 is initially trained on the first dataset 144. The labeled sets of response data of the first dataset are provided to the rationalization model 112 and the machine learning algorithm is configured to determine weights 134 to arrive at the labeled disposition (e.g., retire, retain, replace, rehost, refactor, rearchitect, and re-envision) based on the response data. The rationalization model 112 undergoes supervised learning because the sets of response data are labeled with the correct outcome (i.e., disposition recommendation) during the training phase of the machine learning model.

The rationalization model can be an ensemble model configured to generate a prediction based on predictions from multiple classification models. The classification models are individual machine learning models (e.g., linear regression, logistic regression, etc.) that are individually trained on the baseline response data to generate a recommendation regarding disposition. In this example, the multiple classification models together form the rationalization model. The rationalization model can generate a final recommendation based on individual recommendations made by multiple classification models forming the rationalization model.

In some examples, the rationalization model can be trained based on a logistic regression algorithm. In such an example, the machine learning algorithm is configured to determine (often referred to as “learning”) weights 134 applied to each of the factors to minimize an error between the predicted disposition and a true disposition (i.e., based on the labeled data). In another example, the rationalization model can be trained based on a linear regression algorithm. In this example, the machine learning algorithm is configured to determine (or “learn”) weights 134 applied to each of the factors to minimize an error between the predicted value and a true value. The logistic regression equation is shown in Equation 1. Factors associated with the larger weights 134 are associated with questions with greater impact on the outcome probability than questions associated with smaller weights 134. Accordingly, question importance, which ranks questions in descending order of question impact, can be arranged in accordance with the magnitude of weights 134 corresponding to each factor and, hence, associated with each question 118.

With reference to Equation (1) above, P is the probability that the response data indicates a particular disposition over all other dispositions. Each factor X is a different response from the subset of responses that form a set of response data. Each weight β is a weighting factor for X associated with that weighting factor, and the weighting factors (β1 to βp) are determined (or “learned”) by the rationalization model during training. β0 is a factor representing residual error 132 that is also determined by the machine learning algorithm during training. The logistic regression model is initially trained based on the information in the first dataset. The error can be determined for the logistic regression model based on the predictive accuracy of the logistic regression model for the second dataset. The application rationalization system 100 can utilize training module 116 in successive training rounds to minimize residual error 132 of the logistic regression model based on a new first dataset 144 and new second dataset 146. During each training round, weights β and residual error β₀ can be iteratively determined to minimize error of the logistic regression model.

Once residual error 132 and weights 134 of rationalization model 112 are determined, baseline response data 142 can be used to determine probability difference threshold criterion 140 or criteria 140. During the administration of each survey, there comes a point at which weights 134 associated with the remaining questions are insufficient or likely to be insufficient to exceed the disposition recommendation currently associated with the maximum disposition probability. This point of the survey can be characterized by probability difference threshold 140. Probability difference threshold 140 can be determined by training module 116 based on residual error 132 and weights 134 and may be associated with a particular disposition recommendation, a subset of disposition recommendations, or all disposition recommendations. Where probability difference threshold criterion 140 is associated with less than all disposition recommendations, rationalization model 112 may include multiple disposition threshold criteria 140, each disposition threshold criteria 140 associated with a particular disposition recommendation or a subset of disposition recommendations. Once the disposition probability meets or exceeds established probability difference threshold criterion 140 or criteria 140, the survey can be ended and the disposition recommendation output.

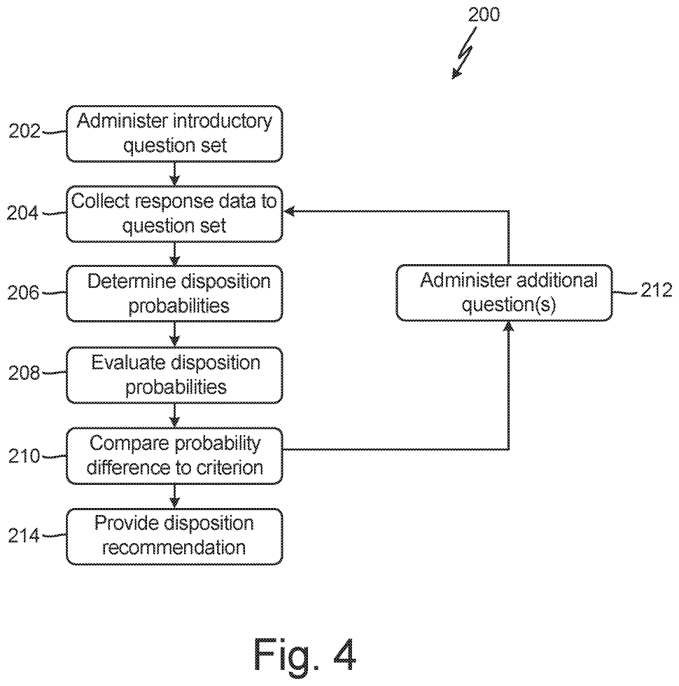

FIG. 4 is a flow chart describing an example method of prioritizing questions implemented by rationalization system 100. The sequence depicted is for illustrative purposes only and is not meant to limit the method 200 in any way as it is understood that the portions of the method can proceed in a different logical order, additional or intervening portions can be included, or described portions of the method can be divided into multiple portions, or described portions of the method can be omitted without detracting from the described above. Method 200 includes steps 202, 204, 206, 208, 210, 212, and 214.

In step 202, survey module 110 administers an introductory set of questions 126 to a stakeholder via user interface 106. In step 204, response data corresponding to each question 118 within the introductory question set 126 is received by survey module 110 via user interface 106. In step 206, rationalization model 112 calculates disposition probabilities 130 corresponding to each potential disposition based on response data, weights, and residual error according to Equation 1. In step 208, comparator module 114 evaluates disposition probabilities 130 with respect to at least one criterion 136. For example, evaluation of disposition probabilities 130 can include ranking disposition probabilities 130 in ascending or descending order and calculating a probability difference between the highest probability and the second-highest probability. The comparator module 114 compares the probability difference to a probability difference threshold criterion 140 in step 210. If the probability difference is less than the probability difference threshold criterion 140, survey module 110 administers at least one additional question 129 to the stakeholder via user interface 106 in step 212. After survey module 110 administers additional question 129 or questions 129, steps 204, 206, 208, and 210 are repeated. If the probability difference is equal to or greater than the probability difference threshold criterion 140, comparator module 114 outputs a disposition recommendation associated with highest probability in step 214. Accordingly, application rationalization system 100 utilizing method 200 can determine a disposition recommendation based on less than all of the questions 118 within a question set, ending the survey prior to the administration of every question 118.

### Discussion of Possible Embodiments

The following are non-exclusive descriptions of possible embodiments of the present invention.

Method of Administering a Survey

A method of administering a survey comprising a first number of questions according to an example embodiment of this disclosure, among other possible things, includes administering an introductory question set to a stakeholder via a user interface and collecting response data from the introductory question set. The introductory question set is selected from a plurality of questions of the survey. The method includes using a rationalization model comprising one or more machine learning models. The rationalization model is used to determine a plurality of disposition probabilities based on response data from the introductory question set. Each disposition probability represents a likelihood a disposition recommendation occurs, the disposition probability selected from a plurality of disposition probabilities. The method includes determining a probability difference based on two disposition probabilities of the plurality of disposition probabilities and comparing the probability difference to a probability difference threshold. The method includes ending the survey at a second number of questions that is less than the first number of questions upon determining the probability difference is equal to or greater than the probability difference threshold.

The method of the preceding paragraph can optionally include, additionally and/or alternatively, any one or more of the following features, configurations, additional components, and/or steps.

A further embodiment of the foregoing method can include outputting a disposition recommendation corresponding to a maximum disposition probability of the plurality of disposition probabilities upon determining the probability difference is equal to or greater than the probability difference threshold.

A further embodiment of any of the foregoing methods, wherein the probability difference can be determined between the highest probability and the second-highest probability among the plurality of disposition probabilities.

A further embodiment of any of the foregoing methods can include ranking the plurality of questions based on question importance.

A further embodiment of any of the foregoing methods wherein the rationalization model can include a plurality of weights, each weight of the plurality of weights associated with one of the plurality of questions.

A further embodiment of any of the foregoing methods, wherein question importance can be assigned in order of decreasing weight associated with each question.

A further embodiment of any of the foregoing methods can include administering an additional question upon determining the probability difference is less than the probability difference threshold.

A further embodiment of any of the foregoing methods, wherein the additional question can be selected from the plurality of questions based a descending order of question importance.

A further embodiment of any of the foregoing methods can include determining, using the rationalization model, a plurality of second disposition probabilities based on response data from the introductory question set and the additional question.

A further embodiment of any of the foregoing methods can include determining a second probability difference based on two disposition probabilities of the plurality of second disposition probabilities.

A further embodiment of any of the foregoing methods can include comparing the second probability difference to the probability difference threshold.

A further embodiment of any of the foregoing methods can include ending the survey upon determining the second probability difference is equal to or greater than the probability difference threshold.

A further embodiment of any of the foregoing methods can include administering a plurality of additional questions upon determining the probability difference is less than the probability difference threshold.

A further embodiment of any of the foregoing methods, wherein each additional question of the plurality of additional questions can be selected based a descending order of question importance.

A further embodiment of any of the foregoing methods can include determining, using the rationalization model, a plurality of second disposition probabilities based on response data from the introductory question set and the plurality of additional questions.

A further embodiment of any of the foregoing methods can include determining a second probability difference based on two second disposition probabilities of the plurality of second disposition probabilities.

A further embodiment of any of the foregoing methods can include comparing the second probability difference to the probability difference threshold.

A further embodiment of any of the foregoing methods can include ending the survey upon determining the second probability difference is equal to or greater than the probability difference threshold.

A further embodiment of any of the foregoing methods, wherein the introductory question set can contain questions with higher question importance than any additional question. A further embodiment of any of the foregoing methods, wherein the rationalization model can include a plurality of weights and a residual error determined during training of the rationalization model.

A further embodiment of any of the foregoing methods, wherein the probability difference threshold can be determined based on the plurality of weights and the residual error.

A further embodiment of any of the foregoing methods, wherein the probability difference threshold can be one of a plurality of probability difference thresholds

A further embodiment of any of the foregoing methods, wherein each probability difference threshold can be associated with one of a plurality of dispositions.

A Computing Device for Administering a Survey

A computing device according to an example embodiment of this disclosure, among other possible things, includes one or more processors and computer-readable memory. The computer-readable memory is encoded within instructions that, when executed by the one or more processors, cause the computing device to administer an introductory question set to a stakeholder via a user interface and collect response data from the introductory question set. The introductory question set is selected from a plurality of questions of the survey. The instructions further cause the computing device to use a rationalization model comprising one or more machine learning models. The rationalization model is used by the computing device to determine a plurality of disposition probabilities based on response data from the introductory question set. Each disposition probability represents a likelihood a disposition recommendation occurs, the disposition probability selected from a plurality of disposition probabilities. The instructions can further cause the computing device to determine a probability difference based on two disposition probabilities of the plurality of disposition probabilities and compare the probability difference to a probability difference threshold. The instructions further cause the computing device to end the survey at a second number of questions that is less than the first number of questions upon determining the probability difference is equal to or greater than the probability difference threshold.

The computing device of the preceding paragraph can optionally include, additionally and/or alternatively, any one or more of the following features, configurations, additional components, and/or steps.

A further embodiment of the foregoing computing device can include instructions that cause the computing device to output a disposition recommendation corresponding to a maximum disposition probability of the plurality of disposition probabilities upon determining the probability difference is equal to or greater than the probability difference threshold.

A further embodiment of any of the foregoing computing devices, wherein the probability difference can be determined between the highest probability and the second-highest probability among the plurality of disposition probabilities.

A further embodiment of any of the foregoing computing devices can include instructions that cause the computing device to rank the plurality of questions based on question importance.

A further embodiment of any of the foregoing computing devices wherein the rationalization model can include a plurality of weights, each weight of the plurality of weights associated with one of the plurality of questions.

A further embodiment of any of the foregoing computing devices, wherein question importance can be assigned in order of decreasing weight associated with each question.

A further embodiment of any of the foregoing computing devices can include instructions that cause the computing device to administer an additional question upon determining the probability difference is less than the probability difference threshold.

A further embodiment of any of the foregoing computing devices, wherein the additional question can be selected from the plurality of questions based a descending order of question importance.

A further embodiment of any of the foregoing computing devices can include comprising determining, using the rationalization model, a plurality of second disposition probabilities based on response data from the introductory question set and the additional question.

A further embodiment of any of the foregoing computing devices can include determining a second probability difference based on two disposition probabilities of the plurality of second disposition probabilities.

A further embodiment of any of the foregoing computing devices can include comparing the second probability difference to the probability difference threshold.

A further embodiment of any of the foregoing computing devices can include ending the survey upon determining the second probability difference is equal to or greater than the probability difference threshold.

A further embodiment of any of the foregoing computing devices can include administering a plurality of additional questions upon determining the probability difference is less than the probability difference threshold.

A further embodiment of any of the foregoing computing devices, wherein each additional question of the plurality of additional questions can be selected based a descending order of question importance.

A further embodiment of any of the foregoing computing devices can include determining, using the rationalization model, a plurality of second disposition probabilities based on response data from the introductory question set and the plurality of additional questions.

A further embodiment of any of the foregoing computing devices can include determining a second probability difference based on two second disposition probabilities of the plurality of second disposition probabilities.

A further embodiment of any of the foregoing computing devices can include comparing the second probability difference to the probability difference threshold.

A further embodiment of any of the foregoing computing devices can include ending the survey upon determining the second probability difference is equal to or greater than the probability difference threshold.

A further embodiment of any of the foregoing computing devices, wherein the introductory question set can contain questions with higher question importance than any additional question.

A further embodiment of any of the foregoing computing devices, wherein the rationalization model can include a plurality of weights and a residual error determined during training of the rationalization model.

A further embodiment of any of the foregoing computing devices, wherein the probability difference threshold can be determined based on the plurality of weights and the residual error.

A further embodiment of any of the foregoing computing devices, wherein the probability difference threshold can be one of a plurality of probability difference thresholds

A further embodiment of any of the foregoing computing devices, wherein each probability difference threshold can be associated with one of a plurality of dispositions.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of administering a survey comprising a first number of questions, the method comprising:
administering, by a computing device, an introductory question set to a stakeholder via a user interface, wherein the introductory question set is selected from a plurality of questions of the survey;
collecting, by the computing device, response data from the introductory question set;
determining, using a rationalization model comprising one or more machine learning models, a plurality of disposition probabilities based on response data from the introductory question set, wherein each disposition probability of the plurality of disposition probabilities is representative of a predicted likelihood of occurrence of a disposition recommendation, the disposition recommendation selected from a plurality of disposition recommendations;
determining, by the computing device, a probability difference based on two disposition probabilities of the plurality of disposition probabilities;
comparing, by the computing device, the probability difference to a probability difference threshold; and
ending the survey, by the computing device, at a second number of questions that is less than the first number of questions upon determining that the probability difference is equal to or greater than the probability difference threshold.

2. The method of claim 1, further comprising:
outputting, by the computing device, a disposition recommendation corresponding to a maximum disposition probability of the plurality of disposition probabilities upon determining the probability difference is equal to or greater than the probability difference threshold.

3. The method of claim 1, wherein the probability difference is determined between the highest probability and the second-highest probability among the plurality of disposition probabilities.

4. The method of claim 1, further comprising:
ranking the plurality of questions based on question importance.

5. The method of claim 4, wherein the rationalization model includes a plurality of weights determined during training of the rationalization model, each weight of the plurality of weights associated with one of the plurality of questions, and wherein question importance is assigned in order of decreasing weight associated with each question.

6. The method of claim 4, further comprising:
administering an additional question upon determining the probability difference is less than the probability difference threshold.

7. The method of claim 6, wherein the additional question is selected from the plurality of questions based a descending order of question importance.

8. The method of claim 6, further comprising determining, using the rationalization model, a plurality of second disposition probabilities based on response data from the introductory question set and the additional question.

9. The method of claim 8, further comprising determining a second probability difference based on two disposition probabilities of the plurality of second disposition probabilities.

10. The method of claim 9, further comprising
comparing the second probability difference to the probability difference threshold; and
ending the survey upon determining the second probability difference is equal to or greater than the probability difference threshold.

11. The method of claim 4, further comprising:
administering a plurality of additional questions upon determining the probability difference is less than the probability difference threshold.

12. The method of claim 11, wherein each additional question of the plurality of additional questions is selected based a descending order of question importance, and wherein question importance is determined based on the plurality of weights.

13. The method of claim 12, further comprising:
determining, using the rationalization model, a plurality of second disposition probabilities based on response data from the introductory question set and the plurality of additional questions.

14. The method of claim 13, further comprising:
determining a second probability difference based on two second disposition probabilities of the plurality of second disposition probabilities.

15. The method of claim 14, further comprising
comparing, by the computing device, the second probability difference to the probability difference threshold; and
ending the survey upon determining the second probability difference is equal to or greater than the probability difference threshold.

16. The method of claim 1, wherein the introductory question set contains questions with higher question importance than any additional question.

17. The method of claim 1, wherein the rationalization model includes a plurality of weights and a residual error determined during training of the rationalization model, and wherein the probability difference threshold is determined based on the plurality of weights and the residual error.

18. The method of claim 17, wherein the probability difference threshold is one of a plurality of probability difference thresholds, and wherein each probability difference threshold is associated with one of a plurality of dispositions.

19. A computing device comprising:
one or more processors; and
computer-readable memory encoded with instructions that, when executed by the one or more processors, cause the computing device to:
administer an introductory question set to a stakeholder via a user interface, wherein the introductory question set is selected from a plurality of questions of the survey;
collect response data from the introductory question set;
determine, using a rationalization model comprising one or more machine learning models, a plurality of disposition probabilities based on response data from the introductory question set, wherein each disposition probability of the plurality of disposition probabilities is representative of a predicted likelihood of occurrence of a disposition recommendation, the disposition recommendation selected from a plurality of disposition recommendations;
determine a probability difference based on two disposition probabilities of the plurality of disposition probabilities;
compare the probability difference to a probability difference threshold; and
end the survey at a second number of questions that is less than the first number of questions upon determining that the probability difference is equal to or greater than the probability difference threshold.

20. The computing device of claim 19, wherein the computer-readable memory is further encoded with instructions that, when executed by the one or more processors, cause the computing device to:
output a disposition recommendation corresponding to a maximum disposition probability of the plurality of disposition probabilities upon determining the probability difference is equal to or greater than the probability difference threshold.
